(19) United States
(12) Patent Application Publication
(10) Pub. No.: US 2017/0021563 A1
(43) Pub. Date: Jan. 26, 2017

(54) 3-DIMENSIONAL PRINTING APPARATUS

(71) Applicant: Korea University Research and Business Foundation, Seoul (KR)

(72) Inventor: Woo Young Yoon, Seoul (KR)

(73) Assignee: Korea University Research and Business Foundation, Seoul (KR)

(21) Appl. No.: 15/213,965

(22) Filed: Jul. 19, 2016

(30) Foreign Application Priority Data
Jul. 20, 2015 (KR) 10-2015-0102146

(51) Int. Cl. B29C 67/00

(52) U.S. Cl. CPC B29C 67/0081; B33Y 30/00

(57) ABSTRACT

A 3-dimensional printing apparatus may include a storage unit, a dispensing unit, and a pressure control unit. The storage unit stores a printing material satisfying Bingham plastic model in which a viscosity is decreased as a pressure is increased. The dispensing unit receives the printing material from the storage unit to ejaculate the printing material. The pressure control unit controls a pressure applied to the printing material supplied in the dispensing unit to control a viscosity of the printing material. Thus, a product having soft characteristics may be manufactured.

### CROSS-REFERENCE TO RELATED APPLICATION(S)

This application claims priority under 35 USC §119 to Korean Patent Application No. 10-2015-0102146, filed on Jul. 20, 2015 in the Korean Intellectual Property Office (KIPO), the contents of which are incorporated herein in its entirety by reference.

### BACKGROUND

1. Technical Field

The present disclosure relates generally to a 3-dimensional printing apparatus. More particularly, the present disclosure relates to a 3-dimensional printing apparatus using a printing material having viscosity changed based on a pressure.

2. Description of the Related Art

A 3-dimensional printing apparatus enables small quantity batch production in almost all fields such as mechanical devices, furniture, toys, etc. Printing material used in the 3-dimensional printing apparatus is developed toward high polymer having relatively low melting temperature, ceramic such as gypsum, metal based material, etc.

Here, the 3-dimensional printing apparatus melts the printing material formed in a shape such as a filament shape and injects or powder is firstly injected and heated in various methods, and then the material is cooled to form a solid shape. Thus, the current 3-dimensional printing apparatus is developed to use material of high melting point, material having better mechanical characteristics (for example, high strength), etc.

However, a product produced using the 3-dimensional printing apparatus may require soft mechanical characteristics. For example, bio tissue or an organ of a body has a solid state, but has soft characteristics. In particular, bio mimetic is used for practice before surgery of doctors or medical students, and has various shapes for different patients, and thus, the 3-dimensional printing technology is required.

### SUMMARY

The present disclosure concerns a 3-dimensional printing apparatus capable of manufacturing a product having soft characteristics by changing viscosity based on a pressure.

In some scenarios, a 3-dimensional printing apparatus may include a storage unit, a dispensing unit, and a pressure control unit. The storage unit stores a printing material satisfying Bingham plastic model in which a viscosity is decreased as a pressure is increased. The dispensing unit receives the printing material from the storage unit to ejaculate the printing material. The pressure control unit controls a pressure applied to the printing material supplied in the dispensing unit to control a viscosity of the printing material.

In those or other some scenarios, the 3-dimensional printing apparatus may further include a temperature control unit controlling a temperature of the printing material supplied in the dispensing unit so that the printing material has a phase in which solid and liquid coexists.

In those or other scenarios, the printing material may maintain a semi-solid state in the dispensing unit.

In those or other scenarios, the printing material may have a gel state in which liquid and solid powder are mixed.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a 3-dimensional printing apparatus.

FIG. 2 is a phase transition diagram illustrating printing material applicable to a 3-dimensional printing apparatus.

### DETAILED DESCRIPTION

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, etc. may be used herein to describe various elements, these elements should not be limited by these terms. These terms are used to distinguish one element from another. For example, a first element discussed below could be termed a second element without departing from the teachings of the present inventive concept. Also, a second element discussed below could be termed a first element without departing from the teachings of the present inventive concept. As used herein, the singular forms are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

Meanwhile, the terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

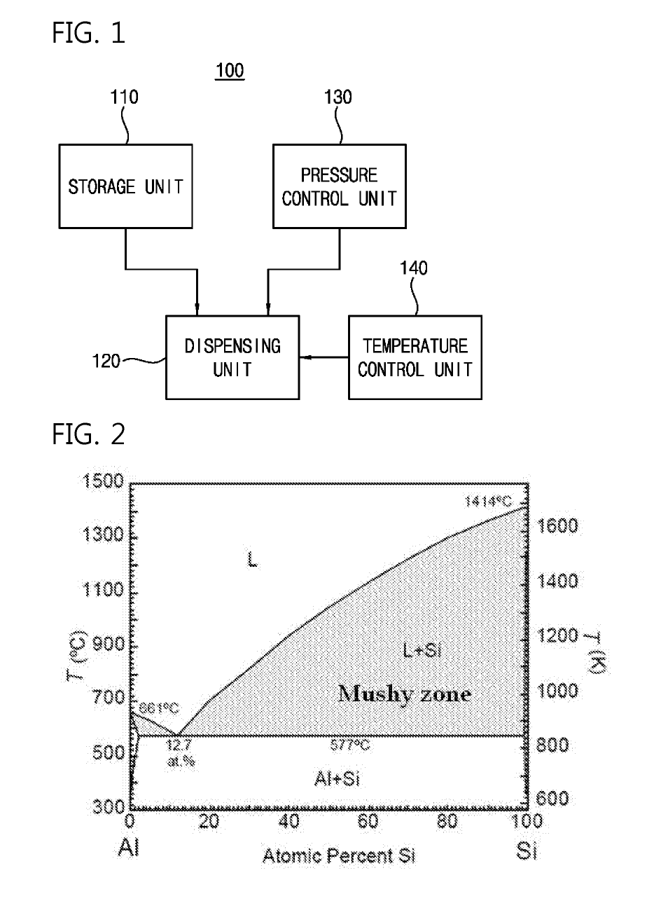

FIG. 1 is a block diagram illustrating a 3-dimensional printing apparatus.

Referring to FIG. 1, the 3-dimensional printing apparatus 100 includes a storage unit 110, a dispensing unit 120, and a pressure control unit 130.

The storage unit 110 stores printing material satisfying Bingham plastic model in which viscosity is decreased as pressure is increased. The storage unit 110, for example, may have a container shape.

When external pressure is applied to the material satisfying Bingham plastic model, viscosity is decreased and fluidity is increased. Meanwhile, when the external pressure is removed, the decreased viscosity is increased again and previous viscosity is recovered. For example, when pressure is applied to a container receiving material such as mayonnaise, ketchup, etc., which satisfies Bingham plastic model, viscosity of the material is decreased to be easily ejaculated from the container. Then, the pressure is removed from the ejaculated material so that the ejaculated material recovers a proper viscosity, and thus, the product including the ejaculated material maintains a fixed shape.

The printing material may be formed by mixing liquid and solid powder.

For example, the printing material may have a gel state in which liquid and solid power are mixed. That is, the solid power including silicon oxide or metal oxide is mixed to physically maintain a gel state.

The dispensing unit 120 is disposed adjacent to the storage unit 110. The dispensing unit 120 receives the printing material from the storage unit 110 to ejaculate the printing material. A product having a predetermined shape may be manufactured based on position and quantity of the ejaculated printing material.

The dispensing unit 120 may include a cylinder (not shown) which stores the printing material and a plunger (not shown) which presses the printing material stored in the cylinder. Since the plunger reciprocates in the cylinder, the printing material stored in the cylinder may be pressed. Here, viscosity of the printing material is decreased by the pressure applied to the printing material. Then, the printing material may be easily ejaculated from the dispensing unit.

The dispensing unit 120 is connected to a driving unit (not shown). The driving unit drives the dispensing unit 120 in X-axis direction and Y-axis direction, and thus, the position of the printing material ejaculated by the dispensing unit 120 may be changed.

The pressure control unit 130 is disposed adjacent to the dispensing unit 120. The pressure control unit 130 may control pressure applied to the printing material supplied in the dispensing unit 120. Here, the pressure control unit 130 may the control viscosity of the printing material. As a result, the dispensing unit 120 may easily ejaculate the printing material toward the outside. Furthermore, as the external pressure is removed from the printing material ejaculated from the dispensing unit 120, the viscosity of the printing material is increased, so that a product having soft characteristics having a predetermined shape may be manufactured.

For example, the pressure control unit 130 may drive a plunger included in the dispensing unit 120. Also, the pressure control unit 130 may control the pressure applied to the printing material using air pressure or hydraulic pressure. Thus, the pressure control unit 130 drives the plunger using the air pressure or the hydraulic pressure, and thus, the pressure applied to the printing material may be controlled.

The 3-dimensional printing apparatus 100 may further include a temperature control unit 140. The temperature control unit 140 may control temperature of the printing material supplied in the dispensing unit 120 so that the printing material may have a phase in which solid and liquid coexists. The temperature control unit 140 is prepared to surround the dispensing unit 120, and may include a heater controlling the temperature of the printing material.

FIG. 2 is a phase transition diagram illustrating printing material applicable to a 3-dimensional printing apparatus.

Referring to FIGS. 1 and 2, the printing material may maintains a semi-solid state in the dispensing unit 120. That is, when the printing material is formed of alloy, and when a ratio of metal components included in the alloy and a temperature of the alloy are controlled, musty zone is formed. The alloy exiting in the mushy zone corresponds to a semi-solid state. The alloy of the semi-solid state satisfies Bingham plastic mode. Thus, the alloy of the semi-solid state is easily ejaculated from the dispensing unit, so that a produce having a predetermined shape may be manufactured. The product of the predetermined shape is solidified by slow cooling, so that the product having the predetermined shape may be manufactured.

In some scenarios, a 3-dimensional printing apparatus using printing material having characteristics of Bingham plastic model, in which viscosity is decreased when a relatively high pressure is applied, is realized, and thus, a pressure is applied to printing material injected in a dispensing unit to decrease viscosity of the printing material. Thus, the printing material is ejaculated from the dispensing unit so that the 3-dimensional printing device may easily manufacture a product. Furthermore, when the applied pressure is released, the viscosity of the printing material is recovered, so that the product formed of the printing material may have soft characteristics.

Meanwhile, a semi-molten state of mushy zone in an alloy system corresponds to a semi-solid state in which the Bingham plastic model is satisfied. Thus, the printing material uses the material existing in the mushy zone of the alloy system, the printing material remaining in the dispensing unit is pressed to ejaculate the printing material. Thus, the product is manufactured using the printing material having increased viscosity, and then the product is slowly cooled and solidified, thereby manufacturing a product having hard characteristics.

The 3-dimensional printing apparatus uses material in which viscosity is decreased as pressure applied to the material is increased, and thus, the product having a predetermined shape and soft characteristics as the external pressure is removed and the viscosity is recovered. Thus, by using the product, a bio mimetic which may be used in a rehearsal for increasing success rate of surgery or transplantation of human or a practice of medical students may be manufactured by made to order, thereby greatly contributing medical development.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A 3-dimensional printing apparatus comprising:
a storage unit storing a printing material satisfying Bingham plastic model in which a viscosity is decreased as a pressure is increased;
a dispensing unit receiving the printing material from the storage unit to ejaculate the printing material; and
a pressure control unit controlling a pressure applied to the printing material supplied in the dispensing unit to control a viscosity of the printing material.

2. The 3-dimensional printing apparatus of claim 1, further comprising a temperature control unit controlling a temperature of the printing material supplied in the dispensing unit so that the printing material has a phase in which solid and liquid coexists.

3. The 3-dimensional printing apparatus of claim 1, wherein the printing material maintains s semi-solid state in the dispensing unit.

4. The 3-dimensional printing apparatus of claim 1, wherein the printing material has a gel state in which liquid and solid powder are mixed.

5. The 3-dimensional printing apparatus of claim 4, wherein the solid powder includes silicon oxide or metal oxide.
